(19) United States
(12) Patent Application Publication
(10) Pub. No.: US 2006/0031075 A1
(43) Pub. Date: Feb. 9, 2006

(54) Method and apparatus to recover a high frequency component of audio data

(76) Inventors: Yoon-hark Oh, Suwon-si (KR); Hyuck-jae Lee, Seoul (KR)

Correspondence Address: STANZIONE & KIM, LLP, 919 18TH STREET, N.W., SUITE 440, WASHINGTON, DC, 20006, US

(21) Appl. No.: 11/125,152

(22) Filed: May 10, 2005

(30) Foreign Application Priority Data
Aug. 4, 2004 (KR) 2004-61423

(51) Int. Cl. G10L 21/00

(52) U.S. Cl. 704/500

(57) ABSTRACT

A method and an apparatus to recover a high frequency component of an MP3 encoded audio signal in an audio decoder. The method includes: generating a filter bank value of a low frequency band from a modified discrete cosine transform (MDCT) coefficient, which is extracted from an input bitstream according to a window type, extracting transient information of a frame according to the window type and selecting a weight coefficient according to the extracted transient information, recovering a filter bank value of a lost high frequency band from the generated filter bank value of the low frequency band, and adjusting the recovered filter bank value of recovered high frequency components according to the weight coefficient.

### CROSS-REFERENCE TO RELATED APPLICATIONS

This application claims priority from Korean Patent Application No. 2004-61423, filed on Aug. 4, 2004, in the Korean Intellectual Property Office, the disclosure of which is incorporated herein in its entirety by reference.

### BACKGROUND OF THE INVENTION

1. Field of the Invention

The present general inventive concept relates to an audio encoding/decoding system, and more particularly, to a method and an apparatus to recover a high frequency component of an MPEG Layer 3 (commonly known as MP3) encoded audio signal in an audio decoder.

2. Description of the Related Art

An audio Moving Pictures Expert Group (MPEG) is a standard of ISO/IEC for encoding stereo audio with high quality and high performance, where ISO stands for International Organization for Standardization and IEC stands for International Electrotechnical Commission. High performance multimedia data compression can be realized by combining MPEG standard audio and MPEG standard video in various application products, such as digital television (DTV), digital video disc (DVD), digital audio broadcasting (DAB), and MP3 players. MP3 audio having an “*.mp3” extension refers to audio encoded by a method of an MPEG-1 audio layer 3 standard. Also, the MP3 audio is encoded using a perceptual coding method in which the amount of coding is reduced by omitting detailed information for which human hearing has a low sensitivity.

However, high frequency components of MP3 audio data may be lost if the MP3 audio data is heavily encoded. Due to this high frequency band loss, tone changes and clarity of sound is degraded such that suppressed and/or dull sounds are output. Therefore, an MP3pro format of a spectral band replication (SBR) method is used to recover the lost high frequency components. Additionally, a post-processing sound quality improvement is applied to the recovered high frequency components.

FIG. 1 is a block diagram illustrating a conventional MP3pro decoder that uses the SBR method.

Referring to FIG. 1, a decoder 110 decodes an input MP3pro bitstream in a frequency domain into pulse coded modulation (PCM) audio data and auxiliary data of a time domain. The PCM audio data is divided into left channel audio data and right channel audio data, and the auxiliary data includes envelope information. A quadrature mirror filter (QMF) analyzer 120 converts the PCM audio data in the time domain into a 32-band low frequency component signal in the frequency domain. A high frequency generator 130 generates high frequency components according to the envelope information such that the high frequency components have a similar standard frequency to that of the low frequency components converted by the QMF analyzer 120. An envelope adjuster 140 adjusts energy of the high frequency components according to the envelope information using a spectrum of a low frequency band. A QMF synthesizer 150 synthesizes the energy of the high frequency components adjusted by the envelope adjuster 140 and the low frequency component signal analyzed by the QMF analyzer 120, converts the synthesized high and low frequency components into audio data in the time domain, and outputs the audio data. Accordingly, the high frequency components are recovered. A channel divider 160 outputs the audio data having a left channel and a right channel that are divided according to the auxiliary data generated by the decoder 110.

That is, the high frequency components of MP3 audio data decoded by the decoder 110 are recovered by post-processors such as the QMF analyzer 120, the high frequency generator 130, the envelope adjuster 140, and the QMF synthesizer 150. However, since the SBR method uses the post-processors, it has the following two problems.

First, after converting a decoded MP3 file into a frequency domain signal, high frequency components are estimated from frequency components of the signal. The estimated high frequency components are converted into a time domain signal, added to the decoded MP3 file, and output. In a conventional MP3 decoding method using the SBR method, two processes of converting between a time domain signal and a frequency domain signal are required. Therefore, the conventional MP3 decoding method that uses the SBR method requires an excessive amount of computation in the time/frequency domain converting processes.

Second, since the MP3pro decoder that uses the SBR method processes spectrum envelope information obtained from an encoder in order to recover high frequency components in the frequency domain, an MP3 encoder that uses other conventional encoding methods may not be used with the MP3pro decoder and must be reconstructed. That is, the MP3pro decoder that uses the SBR method cannot recover high frequency components from a conventional MP3 file that does not include the spectrum envelope information.

### SUMMARY OF THE INVENTION

The present general inventive concept provides a method of recovering a high frequency component of audio data, which reproduces a tone of an original sound that is degraded due to high frequency components lost during a conventional audio codec method. The method of recovering the high frequency component of audio data increases clarity of the tone of the original sound by recovering the lost high frequency components using an MP3 decoding process.

The present general inventive concept also provides an apparatus to recover a high frequency component of audio data by applying the method of recovering a high frequency of audio data.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of recovering a high frequency component of a compressed audio signal, the method comprising generating a filter bank value of a low frequency band from a modified discrete cosine transform (MDCT) coefficient, which is extracted from an input bitstream according to a window type, extracting transient information of a frame of the input bitstream according to the window type and selecting a weight coefficient according to the extracted transient information, recovering a filter bank value of a lost high frequency band from the generated filter bank value of the low frequency band, and adjusting the recovered filter bank value of recovered high frequency components according to the selected weight coefficient.

The foregoing and/or other aspects and advantages of the present general inventive concept are also achieved by providing an apparatus to recover a high frequency component of a compressed audio signal, the apparatus comprising an inverse quantizer to extract an MDCT coefficient by inverse-quantizing an input compressed audio bitstream, an inverse MDCT unit to generate a filter bank value of a low frequency band from the MDCT coefficient extracted by the inverse quantizer, a weight coefficient extractor to extract transient information of a frame according to a window type used by the inverse MDCT unit and to select a weight coefficient to adjust magnitudes of high frequency components according to the extracted transient information, a high frequency band generator to recover a filter bank value of a high frequency band from the filter bank value of the low frequency band generated by the inverse MDCT unit, and a multiplier to multiply the weight coefficient selected by the weight coefficient extractor and the filter bank value of the high frequency band recovered by the high frequency band generator.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional MP3pro decoder using an SBR method;

FIG. 2 is a diagram illustrating an MP3 decoder using a high frequency recovering method according to an embodiment of the present general inventive concept;

FIGS. 3A through 3D illustrate a process of recovering a high frequency component according to an embodiment of the present general inventive concept; and

FIG. 4 is a flowchart illustrating a method of recovering a high frequency of audio data according to an embodiment of the present general inventive concept.

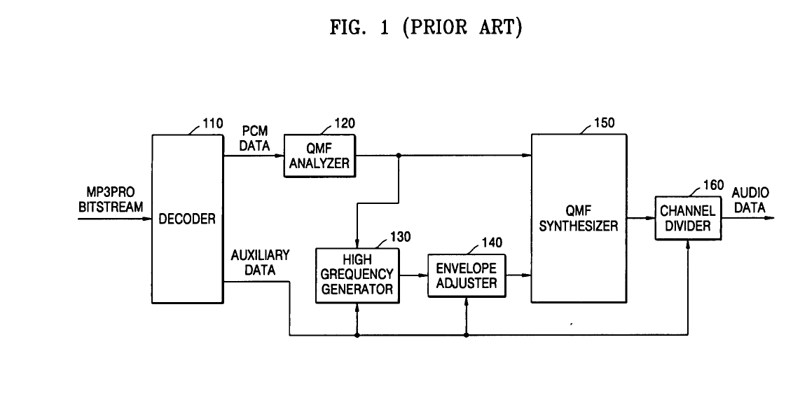

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

An MP3 bitstream input to an MP3 decoder according to an embodiment of the present general inventive concept is formed by the following procedures. First, pulse coded modulation (PCM) audio data is input. Second, the input PCM audio data is divided into 576 samples for each granule (minimum unit for which coding is performed (576 samples)). Third, perceptual energy is obtained by applying a psychoacoustic model of an MPEG-1 layer 3 (MP3) to the samples. Fourth, the perceptual energy obtained from the psychoacoustic model is compared with a threshold value in order to determine modified discrete cosine transform (MDCT) window types. The window types include a long window, a start window, a short window, and a stop window according to an MP3 standard. The windows are overlapped with each other in order to prevent aliasing. A partial portion or an entire portion of the window types can be switched according to the threshold value. That is, if a level of the perceptual energy is larger than the threshold value, the short window is selected since the perceptual energy corresponds to a signal of an attack status in which the energy level increases abruptly. Additionally, if the level of the perceptual energy is smaller than the threshold value, the long window is selected since the perceptual energy corresponds to a signal of a state in which the energy level is constant. Fifth, the samples corresponding to each selected window range are MDCT-processed and are converted into data in the frequency domain. The start window or the stop window is used to switch the long window to the short window, and vice versa. Sixth, the MDCT-processed data of the frequency domain is quantized according to a number of allocated bits. Finally, the quantized data is formed into an MP3 bitstream using a Huffman coding method. The MP3 bitstream includes a plurality of frame units. An MP3 frame format includes a header, side information, and main data. The side information includes information used to decode the main data, such as a scale factor and a window type.

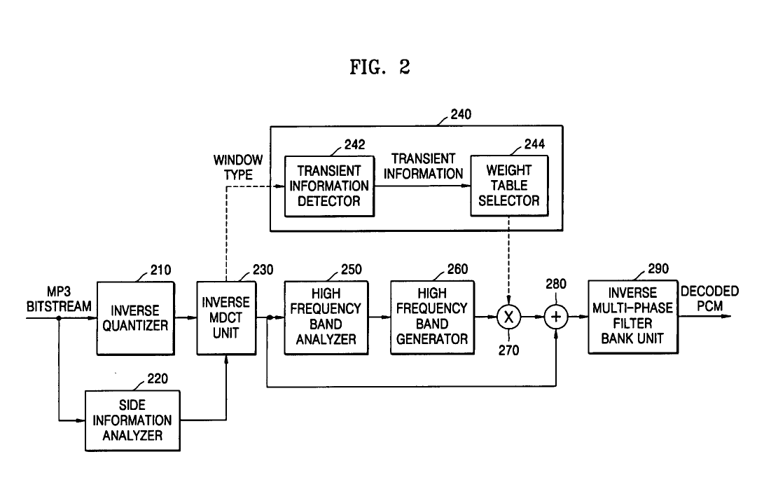

FIG. 2 is a diagram illustrating an MP3 decoder using a high frequency recovering method according to an embodiment of the present general inventive concept.

Referring to FIG. 2, the MP3 decoder includes an inverse quantizer 210, a side information analyzer 220, an inverse MDCT unit 230, a high frequency band analyzer 250, a high frequency band generator 260, a weight coefficient extractor 240, a multiplier 270, an adder 280, and an inverse multi-phase filter bank unit 290. The weight coefficient extractor 240 includes a transient information detector 242 and a weight table selector 244.

The inverse quantizer 210 extracts an MDCT coefficient from an input MP3 bitstream. The inverse quantized MDCT coefficient is distributed in a low frequency band.

The side information analyzer 220 extracts a window type by analyzing side information from the input MP3 bitstream.

The inverse MDCT unit 230 generates a filter bank value according to the MDCT coefficient extracted by the inverse quantizer 210 using the window type extracted by the side information analyzer 220.

The transient information detector 242 detects transient information of a current frame according to the window type used by the inverse MDCT unit 230. That is, the transient information detector 242 determines that the current frame is in a non-transient region when the window type is ‘long,’ the current frame is in a transient region when the window type is ‘short,’ and the current frame is in a transition region when the window type is ‘start’ or ‘stop.’

The weight table selector 244 selects a weight coefficient to adjust a weight of high frequency components according to the transient information detected by the transient information detector 242. For example, a harmonic component having a large weight is selected when the current frame is determined to be in the transient region, a harmonic component having a small weight is selected when the current frame is determined to be in the non-transient region, and a harmonic component having an intermediate weight is selected when the current frame is determined to be in the transition region.

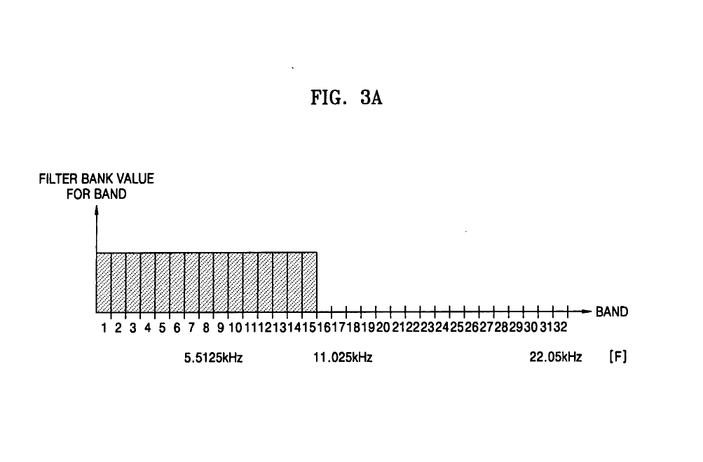

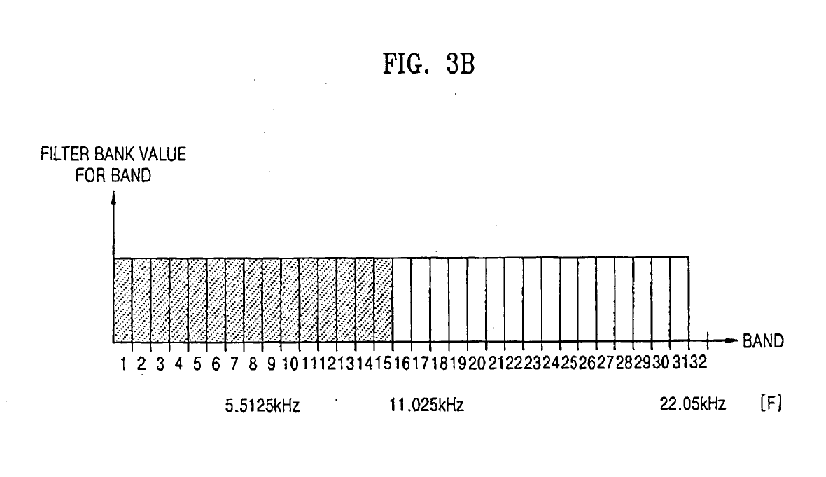

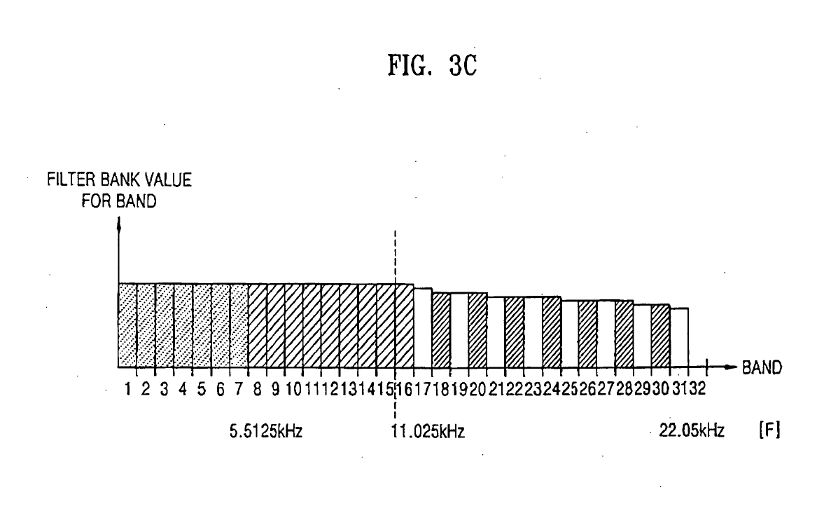

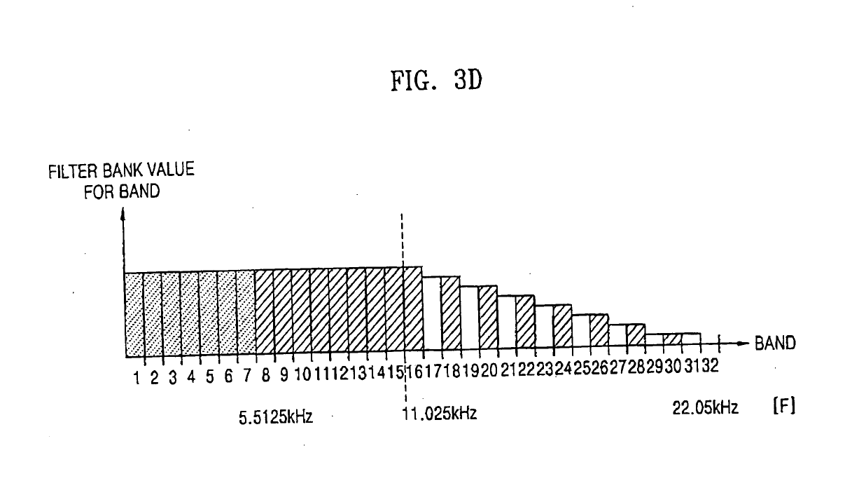

The high frequency band analyzer 250 detects a lost high frequency band by analyzing the filter bank value generated by the inverse MDCT unit 230. For example, referring to FIG. 3A, in a 96 Kbps MP3 file, frequency components having over 11.025 KHz (i.e., filter bank values of bands 16 through 32) among 32 filter bank values are lost. Similarly, although not illustrated, in a 128 Kbps MP3 file, frequency components having over 15 KHz among 32 filter bank values are lost.

The inverse MDCT unit 230 provides frequency domain information about the MP3 bitstream to the high frequency band analyzer 250 such that the high frequency band analyzer 250 can detect the lost high frequency components of the high frequency band, accordingly. In particular, the inverse MDCT unit 230 provides the filter bank values of the low frequency band to the high frequency band analyzer 250. On the other hand, the inverse MDCT unit 230 provides the window type associated with the current frame to the transient information detector 242 of the weight coefficient extractor 240 such that the transient information detector 242 can detect the transient information of the current frame from among a plurality of frames in the MP3 bitstream. The window type associated with the current frame may be determined at the time of encoding the MP3 bitstream. In particular, each of the plurality of frames in the MP3 bitstream may be associated with a corresponding window type. Thus, since the MP3 decoder of the present general inventive concept recovers the lost high frequency components of the MP3 bitstream according to the window type and the low frequency components thereof, conversions between the frequency domain and the time domain are unnecessary.

The high frequency band generator 260 recovers the lost high frequency components detected by the high frequency band analyzer 250. Referring to FIG. 3B, the 96 Kbps MP3 file will now be described as an example. Since the frequency components having over 11.025 KHz among the 32 filter bank values have been lost, filter bank values of the bands 16 through 32 that have a value of “0” should be recovered according to filter bank values of bands 8 through 15. For example, since band 16 has a similar harmonic frequency to a harmonic frequency of band 8, the filter bank value of band 8 is copied to the filter bank value of band 16. Likewise, the filter bank value of band 9 is copied to the filter bank value of band 18. Additionally, according to a human perceptual characteristic, since a bandwidth in which people perceive different frequencies as being the same frequency is wide in a high frequency band, the recovered filter bank value of band 18 is copied to the filter bank value of band 19. Voice sound typically has frequency components below 6 KHz. A problem in that frequency components corresponding to voice sound exist in the high frequency band exists when the high frequency components are generated using low frequency components (i.e., below 6 KHz) including the voice sound. For this reason, the filter bank values of the bands 1 through 7 in a low frequency band below 5.5 KHz are not used to recover the high frequency components.

Referring to FIGS. 3B-3D, since band 16, 18, 20, 22 . . . 30 has a similar harmonic frequency to a harmonic frequency band 8, 9, 10, 11 . . . 15, the filter bank value of band 8, 9, 10, 11 . . . 15 are copied to the filter bank value of band 16, 18, 20, 22 . . . 30. Additionally, according to a human perceptual characteristic, since a bandwidth in which people perceive different frequencies as being the same frequency is wide in a high frequency band, the recovered filter bank value of band 16, 18, 20, 22 . . . 30 are copied to the filter bank value of band 17, 19, 21, 23 . . . 31. And filter bank value of band 32 is abandoned because it hardly affects sound quality.

The multiplier 270 adjusts magnitudes of the high frequency components by multiplying the weight coefficients selected by the weight table selector 244 and the high frequency components as illustrated in FIGS. 3C and 3D. FIG. 3C illustrates recovered harmonic components when a current frame is in the transient region. Referring to FIG. 3C, harmonic components having large weights are generated in the transient region. FIG. 3D illustrates recovered harmonic components when the current frame is in the non-transient region. Referring to FIG. 3D, harmonic components having small weights are generated in the non-transient region.

The adder 280 adds the filter bank value of the low frequency band generated by the inverse MDCT unit 230 to a filter bank value of the high frequency band generated by the multiplier 270.

The inverse multi-phase filter bank unit 290 synthesizes the filter bank values having recovered high frequency components into a sub-band and restores PCM audio data by passing the synthesized sub-band through a synthesizing filter.

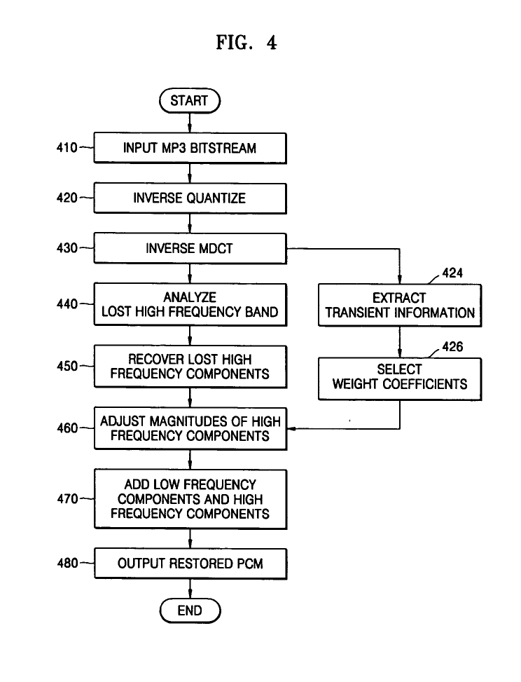

FIG. 4 is a flowchart illustrating a method of recovering a high frequency of audio data according to an embodiment of the present general inventive concept.

Referring to FIG. 4, an MP3 bitstream having compressed audio data including a plurality of frame units is input to a decoder in operation 410.

MDCT coefficients are extracted by inverse-quantizing the input compressed audio bitstream in operation 420. Window types are simultaneously extracted by analyzing side information of the MP3 bitstream.

Filter bank values of a low frequency band are generated by performing an inverse MDCT of the MDCT coefficients according to the window types in operation 430. Transient information is then extracted according to the window types in operation 424, and weight coefficients to adjust magnitudes of high frequency components are selected from a coefficient table according to the extracted transient information in operation 426.

A lost high frequency band is detected by analyzing the filter bank values of the low frequency band in operation 440.

Filter bank values of the high frequency band are recovered from the filter bank values of the low frequency band in operation 450.

The magnitudes of the high frequency components are adjusted by multiplying the weight coefficients selected from the coefficient table and the recovered filter bank values of the high frequency band in operation 460.

The filter bank values of the low frequency band generated by performing the inverse MDCT of the MDCT coefficients and the adjusted filter bank values of the high frequency band are added together in operation 470.

After synthesizing the filter bank values having recovered high frequency components into a sub-band, PCM audio data is restored by passing the sub-band through a synthesizing filter in operation 480.

The present general inventive concept is not limited to the embodiments described above, and it will be understood by those of ordinary skill in the art that various changes in form and details may be made therein without departing from the spirit and scope of the present general inventive concept. That is, the present general inventive concept can be applied to all kinds of audio reproducing devices, such as MP3 players, laptop computers, and PCs, to recover high frequency components of audio data.

As described above, according to embodiments of the present general inventive concept, a conventional MP3 encoder can be used as is, and MP3 sound quality can be improved with a minimal amount of computation, since domain conversion processes which have been conventionally used are unnecessary when recovering lost high frequency components during an MP3 decoding process.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of recovering a high frequency component of a compressed audio signal, the method comprising:
generating a filter bank value of a low frequency band from a modified discrete cosine transform (MDCT) coefficient, which is extracted from an input bitstream according to a window type;
extracting transient information of a frame of the input bitstream according to the window type and selecting a weight coefficient according to the extracted transient information;
recovering a filter bank value of a lost high frequency band from the generated filter bank value of the low frequency band; and
adjusting the recovered filter bank value of recovered high frequency components according to the selected weight coefficient.

2. The method of claim 1, wherein the extracting of the transient information of the frame comprises:
extracting transient information of a current frame with reference to the window type used in an inverse MDCT; and
selecting the weight coefficient to adjust a weight of the filter bank value of the recovered high frequency components according to the extracted transient information of the current frame.

3. The method of claim 2, wherein the transient information comprises transient region information, non-transient region information, and transition region information.

4. The method of claim 2, wherein the current frame is in a non-transient region when the window type is ‘long,’ the current frame is in a transient region when the window type is ‘short,’ and the current frame is in a transition region when the window type is ‘start’ or ‘stop.’

5. The method of claim 1, wherein the recovering of the filter bank value comprises:
multiplying the selected weight coefficient and the filter bank value of the high frequency components.

6. A method of recovering lost high frequency components in a high frequency band of a data bitstream having a plurality of audio frames, the method comprising:
determining one or more filter bank values of low frequency components according to one or more spectral coefficients thereof;
determining one or more estimated filter bank values of the lost high frequency components according to harmonic similarities with the one or more filter bank values of the low frequency components;
adjusting the one or more estimated filter bank values according to one or more corresponding weight coefficients that are determined according to transient information detected in a current frame defined by a window type that corresponds to the current frame; and
combining the adjusted one or more filter bank values and the one or more filter bank values of the low frequency components to obtain a complete frequency band of the data bitstream.

7. The method of claim 6, further comprising:
receiving the data bitstream in a frequency domain; and
converting the complete frequency band of the data bitstream to a time domain and outputting the data bitstream.

8. The method of claim 6, wherein the adjusting of the one or more estimated filter bank values according to the one or more corresponding weight coefficients comprises:
reading side information received with the data bitstream to determine a window type of the current frame;
determining the transient information of the current frame according to the determined window type;
selecting a weight coefficient according to the determined transient information of the current frame; and
multiplying each of the one or more estimated filter bank values by the selected weight coefficient.

9. The method of claim 8, wherein the window type is one of a long window type, a short window type, a start window type, and a stop window type.

10. The method of claim 9, wherein the transient information of the current frame is determined to be in a non-transient region when the window type is the long window type, the transient information of the current frame is determined to be in a transient region when the window type is the short window type, and the transient information of the current frame is determined to be in a transition region when the window type is one of the start window type and the stop window type.

11. The method of claim 9, wherein the selected weight coefficient is large when the window type is the short window type, the selected weight coefficient is small when the window type is the long window type, and the selected weight coefficient is medium size when the window type is one of the start window type and the stop window type.

12. The method of claim 6, further comprising:
receiving the data bitstream including audio data of a plurality of audio frames in the frequency domain and side information including a plurality of window types that correspond with the plurality of audio frames of the audio data.

13. The method of claim 6, wherein the determining of the one or more filter bank values of low frequency components according to the one or more spectral coefficients thereof comprises:
analyzing side information associated with the data bitstream to determine a window type of the current frame; and
generating the one or more filter bank values of the low frequency components according to the one or more spectral coefficients and the window type.

14. The method of claim 6, further comprising:
extracting the one or more spectral coefficients from a low frequency band of the data bitstream.

15. The method of claim 6, wherein the determining of the one or more estimated filter bank values of the lost high frequency components comprises estimating the filter bank values of the lost high frequency components according to similar non-voice frequency components of a low frequency band.

16. The method of claim 6, wherein the one or more spectral coefficients comprise one or more modified discrete cosine transform coefficients.

17. The method of claim 6, wherein the determining of the one or more filter bank values of the low frequency components comprises:
determining an inverse modified discrete cosine transform of the one or more spectral coefficients according to the window type of the current frame.

18. A method of recovering lost high frequency components of a high frequency band of an audio data bitstream received by a decoder, the method comprising:
deriving the lost high frequency components of the high frequency band according to similarities with low frequency components of a low frequency band; and
weighting the derived high frequency components according to transient information of a current frame of the audio data bitstream.

19. The method of claim 18, wherein the low frequency band and the high frequency band comprise 32 filter bank values, and the deriving of the lost high frequency components of the high frequency band comprises recovering filter bank values of bands 16 through 32 according to filter bank values of bands 8 through 15.

20. The method of claim 18, wherein the deriving of the lost high frequency components and the weighting of the derived high frequency components are performed without converting between a time domain and a frequency domain.

21. The method of claim 18, wherein the deriving of the lost high frequency components of the high frequency band comprises copying a filter band value from among lower frequency components in the low frequency band according to human perceptual characteristics.

22. A method of decoding a data bitstream and recovering high frequency components thereof without converting between a time domain and a frequency domain, the method comprising:
receiving the data bitstream including frequency domain information and transient information about the data bitstream;
recovering the lost high frequency components of the data bitstream according to values of similar low frequency components and the transient information about the data bitstream; and
outputting a combination of the recovered high frequency components and the low frequency components in the frequency domain.

23. The method of claim 22, wherein the data bitstream is an MP3 audio data bitstream, and the recovering of the lost high frequency components of the data bitstream comprises:
estimating the lost high frequency components according to the low frequency components; and
weighting the estimated high frequency components according to an expected similarity to the low frequency components determined by the transient information.

24. The method of claim 22, wherein the transient information is carried with the data bitstream as one or more window types.

25. An apparatus to recover a high frequency component of a compressed audio signal, the apparatus comprising:
an inverse quantizer to extract an MDCT coefficient by inverse-quantizing an input compressed audio bitstream;
an inverse MDCT unit to generate a filter bank value of a low frequency band from the MDCT coefficient extracted by the inverse quantizer;
a weight coefficient extractor to extract transient information of a frame according to a window type used by the inverse MDCT unit and to select a weight coefficient to adjust magnitudes of high frequency components according to the extracted transient information;
a high frequency band generator to recover a filter bank value of a high frequency band from the filter bank value of the low frequency band generated by the inverse MDCT unit; and
a multiplier to multiply the weight coefficient selected by the weight coefficient extractor and the filter bank value of the high frequency band recovered by the high frequency band generator.

26. The apparatus of claim 25, further comprising:
an adder to add the filter bank value of the low frequency band generated by the inverse MDCT unit to the filter bank value of the high frequency band generated by the multiplier.

27. The apparatus of claim 25, wherein the weight coefficient extractor comprises:
a transient information detector to detect transient information of a current frame according to the window type used by the inverse MDCT unit; and
a weight coefficient selector to select a weight coefficient corresponding to the transient information detected by the transient information detector from a predetermined coefficient table.

28. A decoder to recover lost high frequency components in a high frequency band of a data bitstream having a plurality of audio frames, comprising:
an input unit to determine one or more filter bank values of low frequency components according to one or more spectral coefficients thereof and to detect a window type of a current frame;
a high frequency band generator to determine one or more estimated filter bank values of the lost high frequency components according to harmonic similarities with the one or more filter bank values of the low frequency components;
an adjusting unit to adjust the one or more estimated filter bank values according to one or more corresponding weight coefficients that are determined according to transient information detected in a current frame defined by the window type of the current frame; and
a combining unit to combine the adjusted one or more filter bank values and the one or more filter bank values of the low frequency components to obtain a complete frequency band of the data bitstream.

29. The decoder of claim 28, wherein:
the input unit receives the data bitstream in a frequency domain; and
the combining unit converts the complete frequency band of the data bitstream to a time domain and outputs the data bitstream.

30. The decoder of claim 28, wherein the adjusting unit comprises:
a side information analyzer to read side information received with the data bitstream and to determine a window type of the current frame according to the read side information;
a transient information detector to determine the transient information of the current frame according to the determined window type;
a weight table selector to select a weight coefficient according to the determined transient information of the current frame; and
a multiplier to multiply each of the one or more estimated filter bank values by the selected weight coefficient.

31. The decoder of claim 30, wherein the window type is one of a long window type, a short window type, a start window type, and a stop window type.

32. The decoder of claim 31, wherein the transient information detector determines that the transient information of the current frame is in a non-transient region when the window type is the long window type, the transient information of the current frame is in a transient region when the window type is the short window type, and the transient information is in a transition region when the window type is one of the start window type and the stop window type.

33. The decoder of claim 31, wherein the weight table selector selects a weight coefficient that is large when the window type is the short window type, small when the window type is the long window type, and medium size when the window type is one of the start window type and the stop window type.

34. The decoder of claim 28, wherein the input unit receives the data bitstream including audio data of a plurality of audio frames in the frequency domain and side information including a plurality of window types that correspond with the plurality of audio frames of the audio data.

35. The decoder of claim 28, wherein the high frequency band generator comprises:
a side information analyzer to analyze side information associated with the data bitstream to determine a window type of the current frame; and
an inverse MDCT unit to generate the one or more filter bank values of the low frequency components according to the window type and the one or more spectral coefficients.

36. The decoder of claim 28, further comprising:
an inverse quantizer to extract the one or more spectral coefficients from a low frequency band of the data bitstream.

37. The decoder of claim 28, wherein the high frequency band generator estimates the filter bank values of the lost high frequency components according to similar non-voice frequency components of a low frequency band.

38. The decoder of claim 28, wherein the one or more spectral coefficients comprise one or more modified discrete cosine transform coefficients.

39. The decoder of claim 28, wherein the input unit comprises an inverse MDCT unit to determine an inverse modified discrete cosine transform of the one or more spectral coefficients according to the window type of the current frame.

40. A decoding apparatus to recover lost high frequency components of a high frequency band of an audio data bitstream, comprising:
a derivation unit to derive the lost high frequency components of the high frequency band according to similarities with low frequency components of a low frequency band; and
a weighting unit to weight the derived high frequency components according to transient information of a current frame of the audio data bitstream.

41. The apparatus of claim 40, wherein the low frequency band and the high frequency band comprise 32 filter bank values and the derivation unit derives of the lost high frequency components by recovering filter bank values of bands 16 through 32 according to filter bank values of bands 8 through 15.

42. The apparatus of claim 40, wherein the derivation unit and the weighting unit, receive the audio data bitstream, recover the lost high frequency components, and output a combination of the low frequency band and the high frequency band without converting between a time domain and a frequency domain.

43. The apparatus of claim 40, wherein the derivation unit copies a filter band value from among lower frequency components in the low frequency band according to human perceptual characteristics.

44. An apparatus to decode a data bitstream and recover high frequency components thereof without converting between a time domain and a frequency domain, the method comprising:
an input unit to receive the data bitstream including frequency domain information and transient information about the data bitstream;
a recovering unit to recover the lost high frequency components of the data bitstream according to values of similar low frequency components and the transient information about the data bitstream; and
an output unit to output a combination of the recovered high frequency components and the low frequency components in the frequency domain.

45. The method of claim 44, wherein the data bitstream is an MP3 audio data bitsream, and the recovering unit comprises:
a high frequency band estimator to estimate the lost high frequency components according to the low frequency components; and
a weighting unit to weight the estimated high frequency components according to an expected similarity to the low frequency components determined by the transient information.

46. The method of claim 44, wherein the transient information is carried with the data bitstream as one or more window types.
